(19) United States
(12) Patent Application Publication
(10) Pub. No.: US 2007/0011650 A1
(43) Pub. Date: Jan. 11, 2007

(54) Computer method and apparatus for developing web pages and applications

(76) Inventors: Antoine Farid Hage, Mansourieh Elmetn (LB); Rafic Elias Hage, Kornet Chehwan (LB); Rony Antoine Saliba, Byblos (LB); Walid Tanios Keirouz, San Antonio, TX (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/449,032

(22) Filed: Jun. 7, 2006

Related U.S. Application Data
(60) Provisional application No. 60/688,222, filed on Jun. 7, 2005.

(51) Int. Cl. G06F 9/44; G06F 9/45

(52) U.S. Cl. 717/104; 717/136

(57) ABSTRACT

Disclosed is a web page development system and method utilizing a common data core (vertical structure and correlated trees for representing web pages) to generate virtual applications based upon the user's interaction, environment (log in IP, stated location, type of device, type of bandwidth, etc.), and pre-set configuration/rights. The present invention provides a multi-stage processing pipeline with data components at the input end and generated web pages at the output end. Different processing engines act at specific stages in the pipeline. These engines provide the functionalities needed in a web application and include security, localization/personalization, page templating and caching. An asynchronous engine enables limiting of processing to only certain (pertinent) portions of a web page. A static adaptation engine integrates dynamic behavior (functionalities) into static web pages. An assembly member assembles a requested web page based on output from the engines.

### RELATED APPLICATION

This application claims the benefit of U.S. Provisional Application No. 60/688,222, filed on Jun. 7, 2005, the entire teachings of which are incorporated herein by reference.

### BACKGROUND OF THE INVENTION

The World Wide Web has become de facto, the standard medium of information for the massive user population. Gathering and dispensing services, web applications have also become vital and ubiquitous to the success of any business activity and have been therefore exponentially growing in complexity. Increased spending plans on content management, sales force automation, marketing automation, procurement and supply chain software and data warehousing among other categories have been envisaged for the end of year 2004. Many firms have progressed in their rollouts of emerging technologies as well. The situation at hand is not concerned with organizations automating their business processes, for this has become a pre-requisite for the successful operation of their needs. The market matured and mindsets have shifted to the management of these information and service systems, and the overall cost of maintaining them. Firms are willing to invest in more expensive systems that guarantee easy and in-house maintainability and customization on the long run.

Implementing and maintaining information and service systems is coupled with the development of enterprise applications. Keeping up with today's constantly changing business challenges requires the fast and reliable projection of enterprise systems on well-founded development models. Application Servers represent the foundation model on which these enterprise applications are built. According to Forrester Research, during the next 12 months, 50% of North American companies will increase their deployment of Application Servers with a 56% majority using .NET for their development work along year 2004. The J2EE platform grabs the other 44% market share. Yet whatever Application Server and platform adopted, it is the mapping of the underlying foundation model to architectural issues in the design of distributed enterprise applications that requires a keener understanding and implementation. Indeed, achieving architectural abstraction and establishing a streamlined development methodology for the creation of enterprise systems, casts out most of the hurdles both authors and users are bound to meet. Application development frameworks, a layered abstraction built on top of Application Servers and platforms are developed to meet this end.

An application development framework is expected to fit many criteria. For one, Internet-based applications have become a relative melting pot of services and technologies and it is the role of the application development framework to fuse them under a common platform and generate if possible, a single programming model. Frameworks should also integrate with legacy and existing systems and aggregate data to leverage existing information assets. Scalability is yet another consideration to handle changing use patterns. Of course, constant transparent security auditing should be maintained all along the different layers and components that make up the framework, and when interoperability between systems occurs. There is no exhaustive requirements checklist for application development frameworks to meet, but the preceding is a start, and existing frameworks should be evaluated accordingly in order to guarantee the development of reliable enterprise systems.

Problem Description

Authors of complex enterprise systems are faced with a plethora of tools, languages, platforms, concepts and technologies, all with their own set of pros and cons. Due to the heterogeneous nature of the web, no single protocol interconnecting multiple environments together exists. Firms have much to gain if they can segment their applications into domains and pinpoint the appropriate platform for each and implement on it. Achieving such flexibility is a virtual impossibility without the adoption of an application development framework that should abstract this diversity under a single development methodological model. For a framework to offer such platform-independent and language-neutral capabilities, it should in itself be based on a solid architecture.

Design patterns define a methodology which names, abstracts and identifies the general aspect of a design structure that mirrors the need for creating an efficient object-oriented design depending on the contextual problem. The contextual problem at hand is the architectural design of application development frameworks. The Model-View-Controller (MVC) design pattern stands out as one of the most recommended architectural design pattern for interactive applications. Frameworks based on the MVC specification tag along substantial benefits and adapt well with the needs and requirements of the web. The MVC design pattern in particular separates business logic from presentation by encompassing the former (data manipulation, extraction and storage procedures . . . ) under the Model component, the latter (data rendering, user interfaces . . . ) under the View component and the control flow between them mandated to the Controller component. Placing business logic and presentation code in separate software layers or architectural components is good design practice that leads to powerful development architectures.

Successfully implementing complex information and service systems is tightly coupled with the application development framework used. It is therefore crucial to pinpoint the best available framework that promotes rapidity and ease of development, scalability, correctness, flexibility, security and ease of maintainability and customization. The extent to which frameworks offer the preceding depends on their underlying architecture. The implementation of such frameworks is questioned. The Apache Struts framework stems as the most prominent MVC-based application development framework to date. Built on the Java platform, Struts is an open source development framework whose aim is to make the developers' tasks easier in developing large-scale web applications. It constitutes a solid, secure and maintainable foundation on top of which developers are able to concentrate on building their applications while abstracting, to some degree, the hurdles encountered while developing for the web.

Struts is ultimately a juiced-up version of the Model-2 specification which first introduced the MVC design pattern for the web. The framework implements a new front Controller component that bundles and directs user requests to other objects in the architecture. Many libraries and features are embedded as well, rendering the job of developers easier in developing applications. Fundamentally, Struts provides a highly automated way of implementing the MVC architecture and adds nothing new to the paradigm. While this in no way devalues the framework's capabilities, it does on the other hand limit its power only to the benefits gained by adopting an MVC specification.

### SUMMARY OF THE INVENTION

There is a strong need for a coherent, easy-to-use programming model for building web-enabled applications. Developers new to this domain are forced to learn a myriad of languages and APIs just to build simple applications. Advanced web developers are forced to write tedious plumbing (“glue”) code on the client and server sides. Web developers need next-generation tools as they move beyond simple languages to service-oriented-architectures for both development and integration. The present invention addresses these needs and provides a next generation framework for developing web applications based on a new programming model.

In particular, the present invention is a web development framework that establishes a heterogeneous architecture and easy to use programming model so that any solution built on top of it will be compatible at the same time with PHP, J2EE, .NET or any other technology.

As such the present invention provides a consistent, abstract, and easily toolable programming model, providing a way for developers to more productively build applications leveraging the latest technology provided by PHP, J2EE, and/or .NET.

In the preferred embodiment, the present invention augments MVC and integrates the following functionalities in its hybrid-MVC design pattern: dynamic workflow creation and manipulation, content integration and aggregation, capabilities management, centralized knowledge bases, constant security auditing down to the field level, and locale consideration, all within a single platform-independent and language-neutral framework. As a result, the present invention enables the authoring of complex disparate systems in great speed, reliability and security while guaranteeing easy maintenance and management of the implemented business processes.

This is accomplished by the present invention providing a multi-stage processing pipeline with data components at the input end and generated web pages at the output end. This pipeline provides hooks that allow processing engines to act at specific stages in the pipeline. These engines provide the functionalities needed in a web application. In a preferred embodiment, these engines include: a caching engine, a template engine, security/access rights engine, a localization/personalization engine, and other engines.

Further, the present invention is not a code generator tool, it provides a unique methodology and techniques that distinguish it from these tools. The present invention provides a solid methodology and a collection of objects on top of which additional layers can be built to form web applications. In addition, embodiments of the present invention provide a set of wizards that allow a computer literate business person to build any layer.

The present invention also separates the business logic of an application from the way it looks. Through this separation, developing an application or merely changing the look and feel of an already developed web application is done in a matter of days by updating a set of templates, a task that can be carried by any web site designer. Each task is reserved to particular entities whose duties need not exceed junior level work.

Code generating tools can act as feeders for the present invention. Developers can use these tools to generate code and add them into the present invention as actions and use the present invention to build the presentation layer as well as the business logic layer. Code generating tools act as additional value-added-services for the present invention as well as the existing web services.

The present invention also acts as a middleware that integrates and aggregates information from any given data source (Relational Database, XML, APIs, I/O, Sockets, etc . . . ), existing web applications, and existing legacy applications.

The present invention fully integrates with the application server (.NET, PHP, J2EE) to process the web application and automatically generate the client side code (HTML, JS, XML, FLASH, etc . . . )

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a schematic diagram of a Concept A and a Concept B and interaction therebetween.

FIGS. 2a-2c are schematic views of five components that form Concept A and operations and functional processes surrounding them.

FIG. 3a is a schematic view of the Template engine templates layered over the Concept A structure of FIG. 2.

FIG. 3b is a block diagram of the results of each template layer of the Template engine 27.

FIG. 3c is a schematic illustration of an assembled web page based on the above templates.

FIG. 4a is a graph of Module versus Member/Group versus Locale as used by the Localization engine in a pre-processing localization phase.

FIG. 4b is a graph of Field Mode versus Personalization Space versus Field Template 25 as used by the Localization engine in a final localization process.

FIG. 5 is a schematic diagram of the Security engine rendering a customized page per user fitting the user's criteria and specifications.

FIG. 6 is a schematic view of a sample workflow.

FIG. 7 is a schematic diagram of the Personalization engine of a preferred embodiment.

FIGS. 8-10e are block and schematic diagrams of preferred embodiments.

FIGS. 11a-11b are schematic views of a static adaptation engine of the preferred embodiment.

FIGS. 12a-12b are schematic views of computers in a network embodying the present invention.

### DETAILED DESCRIPTION OF THE INVENTION

A description of preferred embodiments of the invention follows.

Web applications development is now recognized as a serious software development effort that requires sound development methodologies and practices. There was a widespread belief during the Internet boom and the years immediately following it that almost anybody can develop a website and, by extension, a web application.

To put things into perspective from a technical point of view, developing web applications is actually more difficult than developing traditional applications. The web as a software development framework forgot (or ignored) the software development lessons learned in the first half-century of computing. By default, the web considers each “page” as a separate application. Cookies were added as an afterthought to allow these pages to communicate with other. However, it was still the programmer's responsibility to use these cookies wisely and safely. Web applications present a new security problem as they are subject to a far wider range of security-related attacks than traditional applications ever were. An additional complication is the range of available web technologies that programmers must master. As a result, web applications are notoriously difficult to develop and, more importantly, test and secure properly.

J2EE started the trend of providing a more serious framework for developing web applications. However, these frameworks still require programmers to carry out a lot of tedious work and to manage low-level details. There is now a second generation of frameworks that build on top of J2EE and other such similar frameworks to make it easier to develop web applications.

To add another layer of complexity, the universality of web applications conflicts with specialization and customization. Every community of users likes to believe that it has its own requirements. The Applications Service Provider model (ASP) assumes that one organization will host and deliver the same web application to a variety of user communities while making it appear to each community that it has a different product. This ASP model imposes additional requirements on the software development efforts. The developers must always keep in mind the need for a separation of content and form. However, the web encourages exactly the opposite behavior. Once again, web development frameworks promise to remedy this issue.

Considering the web and web applications from a user's perspective, the browser has emerged as the universal user interface in the IT world. It is available on all platforms (including mobile devices). Users are familiar with its click-and-follow interface. It can access any service provided anywhere on the Internet from anywhere. As a result, the browser has emerged as the preferred interface through which users will access applications and services which do not require the transmission of very large amounts of data and high-end computing. This category includes most business applications except for desktop applications such as Excel™ and PowerPoint™.

A product is an unchangeable entity with which users interact differently depending on their need and use for it. The success of a product relies on how much it meets its user's expectations. Ideally, products could be molded specifically to each user's requirements, but this is unfeasible as it is economically challenging.

A web application is a product with which users interact. Web applications ultimately process data. The user who accesses the data defines how this process is undergone. So a user tags along a list of requirements and expectancies as to how the web application should behave. The requirements and expectancies define the process behind the web application. Who is accessing the data, what data is accessed, what should be secured and what and when should processes be invoked are some of the questions that vary from one user to the other.

Embedding all these operational rules into a web application and satisfying personalized user's requirements is no straight forward task. It demands complex design and implementation of web application systems. In the usual implementation, users interact with the web application which in turn communicates with some form of data source. Specific user rules are embedded within the code of that same web application. The complexity in embedding and maintaining those rules depends on the web application's implementation.

Ideally, each user should have his/her web application, providing an undisputable personalized service. The web application would be tailored to its user's strict and unique requirements while abiding to the application specifications. The aim of the present invention is to achieve this ideal state with no added development complexity.

Abstract View

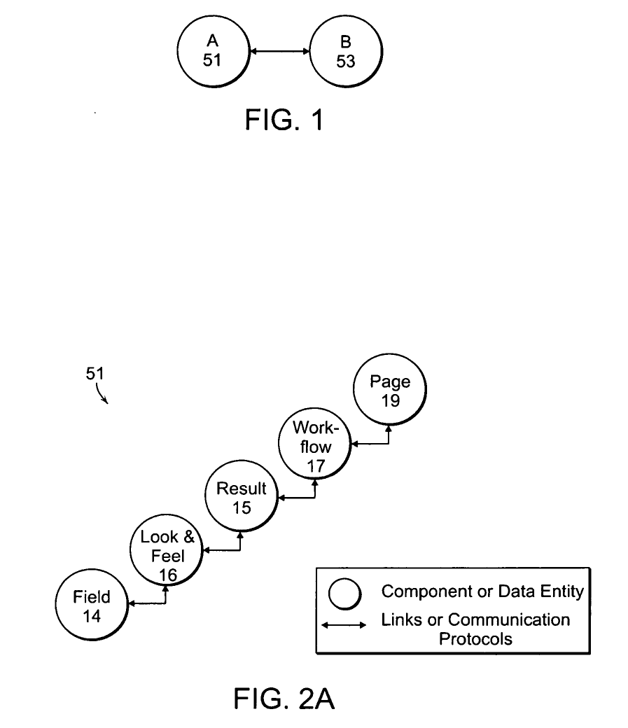

In achieving this ideal state, Applicants represent the following as illustrated in FIG. 1:

What is Concept A?

Concept A's representation 51 conveys the following:
Concept A is a bottom-up linked hierarchy.
The hierarchy is made of a number of self-contained components.
Components are connected using well defined links.
A minimum number of components is needed for Concept A to be well defined.
The mandatory components are all of equal value.
Components can be added to the hierarchy for extra definition.
   What is Concept B?

Concept B's representation 53 conveys the following:
Concept B is a set of self-contained components.
A minimum number of components is needed for Concept B to be well defined.
The mandatory components are all of equal value.
Components can be added for extra definition.
Concept B's components relate to Concept A's components. This defines the interaction between the two Concepts.
   How is the interaction between these two Concepts defined?

The interaction representation conveys the following:
Relationships exist between components from Concept B (B-components) and components from Concept A (A-components).
The relationships are unidirectional: B-components relate to A-components, and not vice-versa.
The relationships are one-to-many: B-components can relate to one or many A-components.
The relationships are well defined links.
   Context-Specific View

From the preceding abstract requirements, the concepts and their interactions are defined within a context-specific environment.

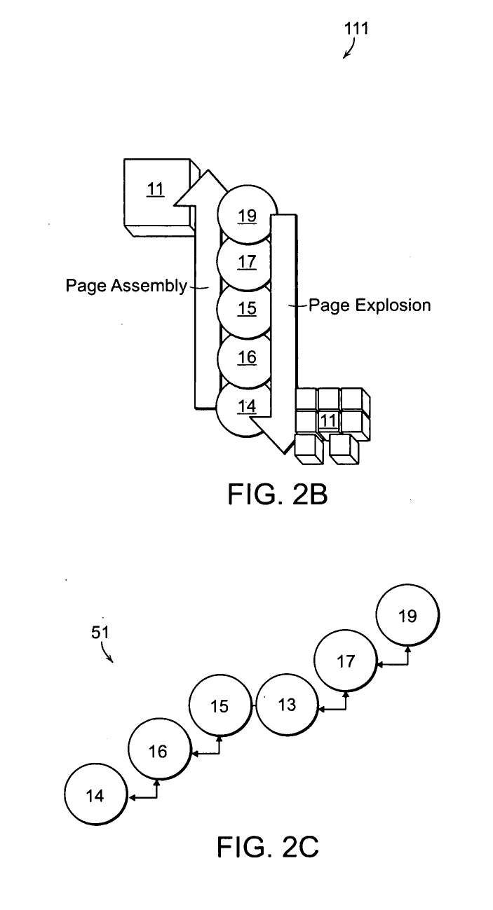

Turning to FIG. 2a, A-Components are independent data entities. In one embodiment, Concept A defines the following self-contained components:
1. Field Component 14
2. Look and Feel Component 16
3. Result Component 15 and Action Component 13 (FIG. 2c)
4. Workflow Component 17
5. Page Component 19

Each component is self-contained, meaning each defines a data entity in its own context.

The five components are defined in a hierarchy which works bottom-up, starting by the Field component 14 up to the Page component 19. The components are linked by well defined communication protocols. All of the five mandatory components are of equal value in defining Concept A. Additional components can be added to the hierarchy.

The hierarchy is oriented from one component—or data entity—to the other. The justification for that order will become clear when each of the five components is explained. But the purpose of the hierarchy itself is to achieve an assembly/explosion process of a page 11 (a page is any final screen output in a web application) as shown in FIG. 2b. As one goes up in the hierarchy, a page 11 is assembled. As one goes down the hierarchy, a page 11 is exploded.

The hierarchy of the components 14, 15, 16, 17, 19 mirrors an n-layered structure (in this case a 5-layered one). Layers are superimposed to define a page 11. Communication protocols handle the stacking procedure, and so the page 11 assembly/explosion process 111 is well defined. Operations can now be safely performed on each individual layer without affecting that process. Such operations are implemented by the B-components.

Field Component 14

Any information in a web application is bounded to a Field. A Field can take on many forms, and can originate from any source. A Field originating from IBM's DB2 Database is no more different than a one fetched from an XML file or from standard manual user input: A Field is a member of the Field component 14.

The Field's originating attributes are automatically associated to it. If a Field is set to be an integer in its SQL Server table, then it is automatically defined as an integer within the web application. Security measures are automatically applied to it, such as client and sever-side type-checking routines among others.

The Field is the first component considered within the hierarchy. It is the first most basic entity needed in building a page.

Look and Feel Component 16

Since Fields can take on any form and originate from any source, a central knowledge base for each is defined. The Look and Feel (L&F) component 16 is responsible for just that, whereby each Field within the web application is associated with a corresponding data entry in one of the L&F entities. An L&F data entry also defines the properties and behaviors of the Field within particular contexts and situations in the web application.

The following relationship rules between an L&F entity and the Fields it encompasses apply:
The relationship is unidirectional.
The relationship is one-to-many: an L&F entity relates to a minimum of 1 Field.
The relationship is disjoint: no two L&F entities relate to the same Field.
There can not be more L&F entities than Field entities.
   Result Component 15

The Result component 15 represents the set of information a page 11 conveys. It is then a collection of Fields. Since each Field is tied to its respective L&F entity, a Result delimits the L&F entities to use, and so automatically are made accessible the available corresponding Fields.

The Result component 15 also renders the properties and ensures the correct behavior on the Fields as specified in their corresponding data entry in the L&F component 16. If the Result component 15 is to display a list of data for example, it automatically enables searching, filtering, sorting, indexing and paging criteria among others on the information displayed.

The following relationship rules between a Result and an L&F entity apply:
The relationship is unidirectional.
The relationship is many-to-many.
The same L&F entity can relate to more than one Result.
A Result can relate to a minimum of one L&F entity (which in turn can relate to many fields).
   Action Component 13

Before detailing the Workflow component, the Action component 13 is introduced next with reference to FIG. 2c. The Action component 13 lies parallel to the Result component 15 in the hierarchy.

The Action component 13 has been only implied until now because its definition is not dependent on Concept A itself, meaning it can be implemented in any way deemed favorable. An Action entity embodies a functional process whose operation depends on the context of the application. Its implementation may be handled by any programming environment.

The boundaries of the component on the other hand are well defined with communication protocols enabling the Action entities to catch the state and values of defined Fields within the parallel Result entities and perform operations on them as required.

Workflow Component 17

With Actions and Results in hand, the Workflow component 17 can be defined: It is a set of Action and Result entities linked together in a way so as to mirror some form of business logic. Business logic is any operational process which presents the user of the web application with data and methods of operation on this data. Different business logics could be built by varying both the entities and the links that define the Workflow. The number of Workflow entities is limited to the number of combinations possible between Results and Actions. No matter the structure of the Workflow, seamless Result and Action interaction is maintained by the adoption of links, or communication protocols, which define the components boundaries.

The following relationship rules between the Workflow entity and both Result and Action entities apply:
Both relationships are unidirectional.
Both relationships are many-to-many.
Both Results and Actions can relate to more than one Workflow.
A Workflow has at least one Result or one Action entity.
A Workflow can relate to as many Results and Actions as needed.
   Page Component 19

As the name suggests, the Page represents the last top component in the hierarchy. It is what the user ultimately sees and interacts with. The Page is composed of Workflow entities and so represents a consolidated workspace, built over a set of Workflows.

The following relationship rules between the Page and Workflow entities apply:
The relationship is unidirectional.
The relationship is many-to-many.
The same Workflow can relate to many Pages.
A Page has at least one Workflow entity.
A Page can have as many Workflows as need be.
   Concept B

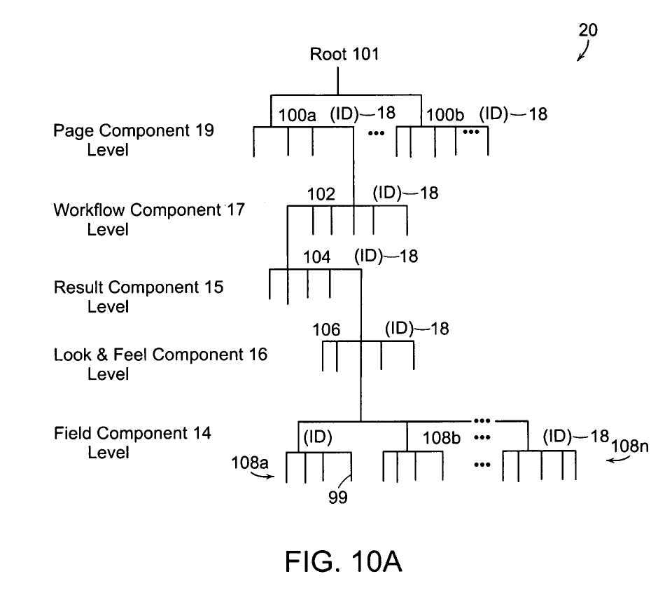

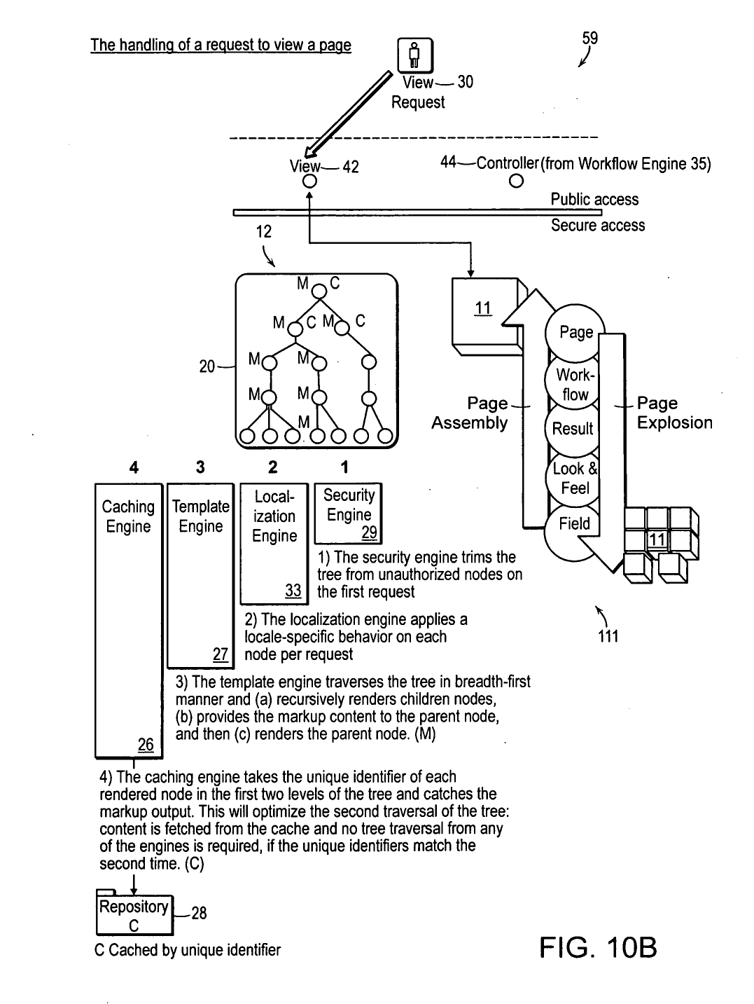

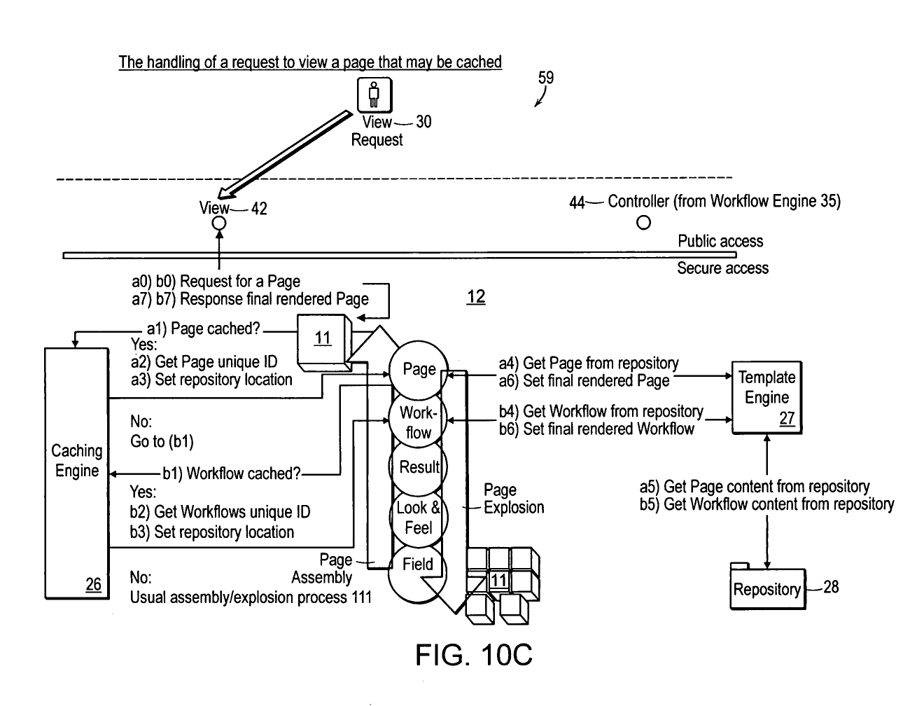

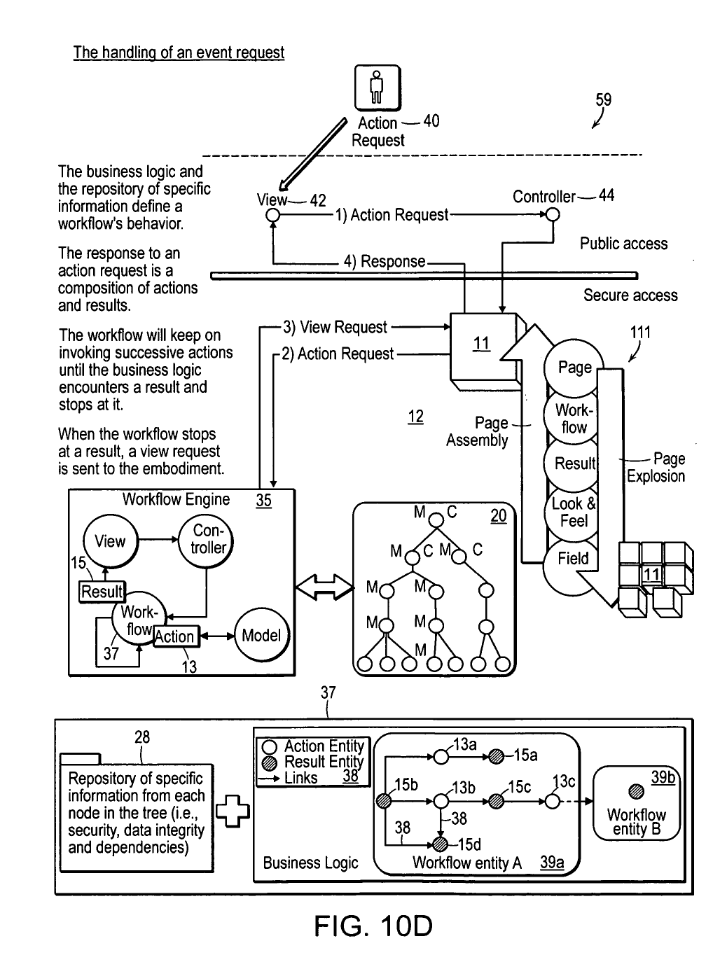

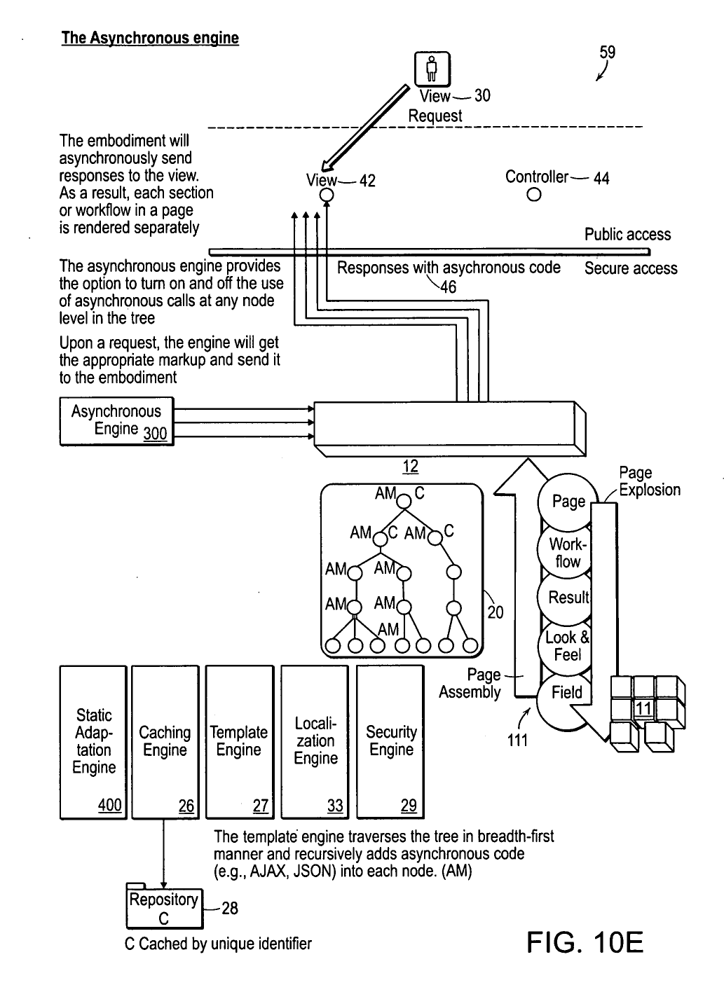

B-Components are distinct engine implementations. In one embodiment, Concept B defines five engines (collectively referenced 53) operation of which is further detailed later in FIGS. 10b-10e:

1. Caching Engine 26

2. Template Engine 27

3. Localization Engine 33

4. Security Engine 29

5. Workflow Engine 35

These components are of equal value, each answering a specific need. Other engines can be added for extra definition. As the components are defined, the interaction between Concepts A and B becomes clear.

Caching Engine

The Caching engine's 26 purpose is to speed up as much as possible the content delivery process. The engine works on the top 2 levels of Concept A's hierarchy and determines whether processing on any of these 2 levels is needed or a simple data fetch suffices:

Page: If no data change is evaluated within the whole of a page 11, the Caching engine 26 loads the page 11 as is and delivers it to the concerned output. This is the fastest type of cache loading.

Workflow: A Page 11 is a collection of workflows 37. If no change is evaluated on a workflow 37, then its output is simply fetched from the cache 28. If on the other hand a process is initiated on a particular workflow 37, then that workflow 37 is reevaluated alone and its output handled for probable later use by the Caching engine 26. That said, certain parts of a page 11 could be loaded from the cache 28 (FIGS. 10b-e) while others are processed.

Caching Engine

Although the Caching engine 26 acts at the page 19 level and workflow 17 level, by detecting changes (or lack thereof) at these levels and avoiding regeneration of the page 11 or result, the caching engine 26 can similarly operate at any level 14, 15, 16, 17, 19 in a page's 11 hierarchical decomposition to speed regeneration of the page 11. In one embodiment, the caching engine 26 operates at the various levels in a tree 12 (FIGS. 10a-e) and computes the signatures of each node's contents during the reconstruction of a page 11. It then uses these signatures to avoid regenerating these nodes during a subsequent reconstruction of the page 11. Various methods and techniques known in the art are used to compute the signatures, e.g., indexing by node's unique identifiers 18, detailed later.

Template Engine 27

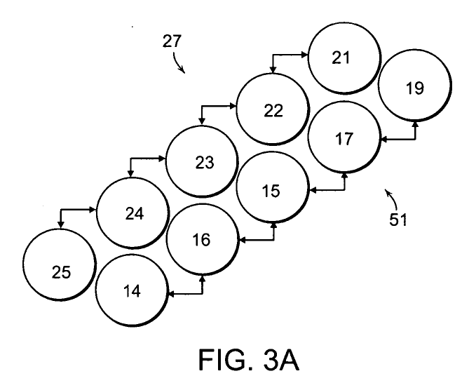

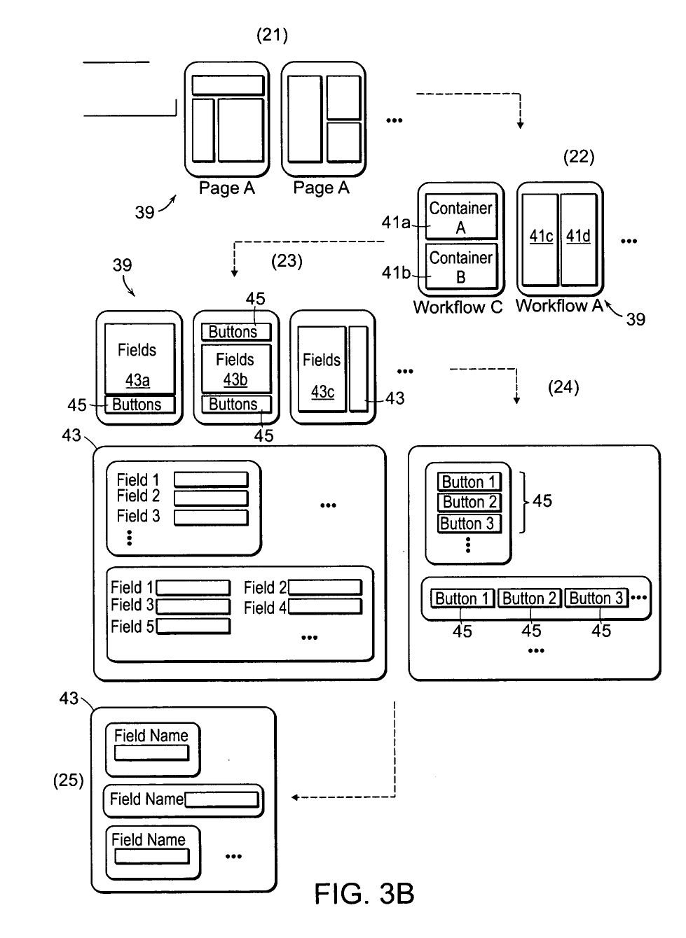

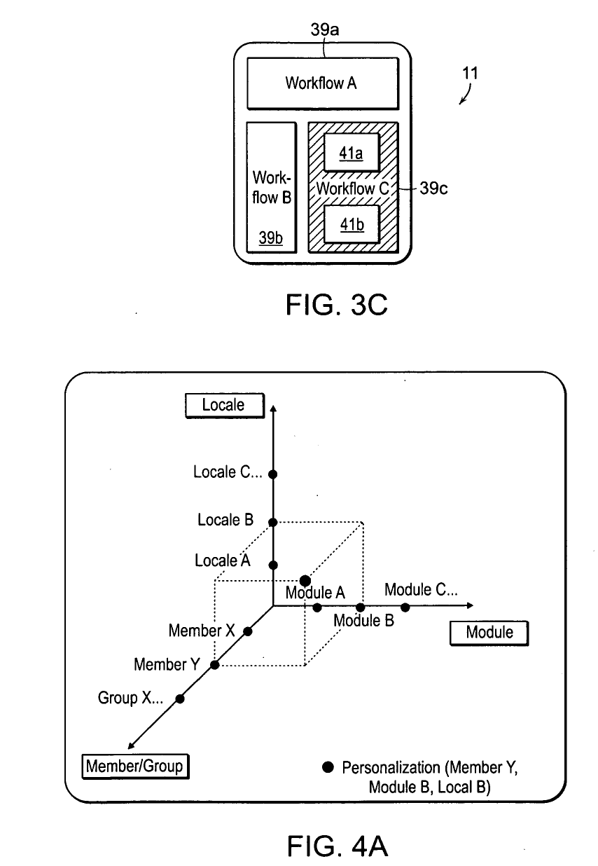

The Template engine 27 achieves efficient design development. It leads to maximum design reusability by layering templates over the leveled Concept A structure. FIG. 3a is illustrative.

The whole design process, embodied by the engine 27, is based on a hierarchical template structure. As opposed to how the hierarchical structure of Concept A was presented, a top-down view is adopted here: It is more illustrative to dissect a page design structure than to explain each design piece alone and the stitching process that accompanies it.

Note that the templates do not include any scripting code. The templates contain pure rendering code, and no preprocessing routines or data manipulation functionalities. Any web designer can design without dealing with coding concerns: designers focus on design, and developers focus on the business logic with total physical and logical separation between these two entities. Because of this hierarchical structure, the templates on each level, are very simple and light in rendering code. As a result, there is no need for the developer to learn any new language associated with template engines in general.

The preferred Concept A hierarchical structure is defined by five components. Layering templates over each component involves in turn the adoption of five levels of templates as illustrated in FIG. 3b. The following description refers to FIGS. 3a and 3b.

The Page Template 21

The Page component 19, detailed as part of the definition of Concept A, is said to be composed of Workflow entities 39. The Page template 21 delimits where these Workflows entities 39 should be placed within the Page component 19. Preferably, a page template is a hierarchy of specialized templates. Each such specialized template acts on a particular individual level in the Concept-A structure as this structure is reflected in the hierarchical decomposition of a page 11. The specialized templates are selected according to a user's profile and security credentials to enable the further personalization of web applications 12 to individual users. Templates achieve complete separation of rendering from coding since they include no scripting code.

The Result Template 22

A Result component 15, detailed as part of the definition of Concept A, is a collection of fields. Related Fields are included within the same form (or containers)

41. Many forms 41 can be included and so the Result template 22 delimits where they should be placed with respect to the Workflow entity 39 that holds them.

The Container Template 23

In any web application, there are fields 43 and buttons 45. The Container templates 23 are responsible for delimiting where the fields 43 should be placed with regards to locations of buttons 45.

The Layout Template 24

The Layout templates 24 delimit how the data and buttons 45 themselves should be rendered. Fields 43 can for example be placed in rows or simply placed side by side horizontally. The middle portion of FIG. 3b is illustrative.

The Field Template 25

The Field Templates 25 deal with how the fields 43 themselves should be rendered. A field's label can for example be placed beside the corresponding field window/area or on top of it.

Localization Engine 33

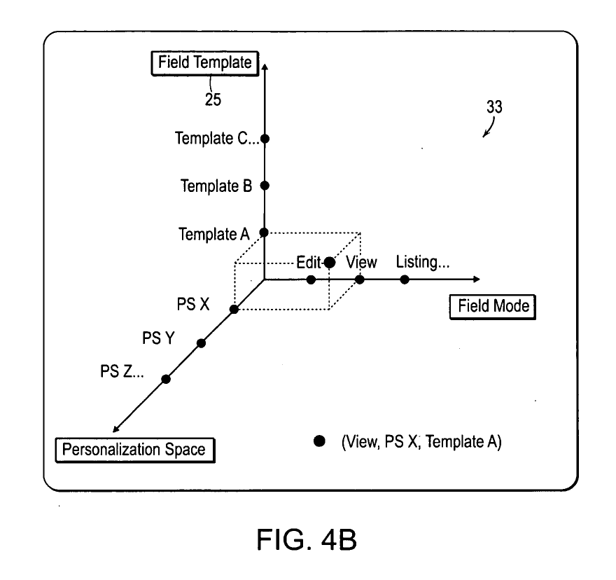

Turning to FIGS. 4a and 4b, the localization engine 33 works on top of each A-component and achieves the correct localization process for each user through two steps:
1. Delimit the user's unique ‘Foundation’ point.
2. Based on the Foundation point, delimit the current working environment's state.

The Foundation point is based on a 3-state context (see FIG. 4a) that delimits the current module the user is interacting with and his/her attached preferred locale settings (localization parameters) for that module. The point associates users with their preferred language, currency, theme, field behavior (such as zip code formats . . . ) depending on the underlying working module.

Based on the Foundation point, the localization engine 33 delimits the possible Field template 25 (see Template Engine 27 of FIG. 3a) and Field mode capabilities that can be assigned for the user (see FIG. 4b). The same Field is rendered differently depending on the context of the web page 11. The context depends on the user, the module accessed, the current mode and the chosen template. These criteria, when combined, delimit a specific localization environment by acting differently on each A-component 51.

For example, the dotted line box in FIG. 4b shows how Template A is used when personalization space X (“PS X”) accesses a particular field in “View” mode. That same member can view the same field differently if the current page mode was set to “Listing”. In a preferred embodiment, the Localization engine 33 uses the following triplet to determine the locale setting of a module as it presents itself to the user: (1) the user, (2) the user's locale setting and (3) the module that the user is interacting with. The locale settings control the rendering and security of a web application 12 as the web application 12 appears to the user. The locale settings select and customize workflow entities 39 appearing on a page 11 for a particular user.

Security Engine 29

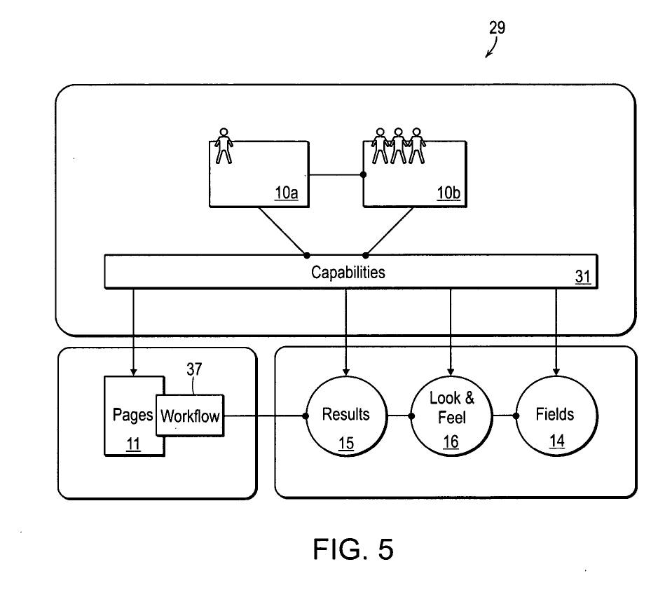

The security engine 29 (FIG. 5) has different roles for each A-component.

Field and Look & Feel Components 16

As previously stated, each Field within the web application 12 is associated with a corresponding data entry in one of the Look and Feel (L & F) entities. This data defines the properties and behaviors of the Field within particular contexts and situations in the web application.

The security engine 29 (FIG. 5) directly applies filtering masks on the fields depending on their properties as defined in their L&F entity. Filtering masks are client and/or server-side property-checking routines applied on the fields. Filtering masks can be customized.

For example, if a field 43 is defined as an integer within a form, both client and server-side type checking routines are applied on the field 43, filtering any erroneous attempt of filling non integer data into the field 43.

Result Component 15

As previously stated, a Result component 15 contains sets of Fields. The security engine's 29 purpose at this level is twofold:
1. Selects different sets of fields for different users as required.
2. Selects the correct field definitions (behavior and layout) for different users as required.

The security engine 29 first handles the displaying and hiding process of fields for the different users of the application 12. Note that hidden fields are non present in the forms and are not just tagged with a hidden HTML attribute. The engine 29 then ensures that the correct rendering of the fields is achieved depending on the context and the user.

For example, while some users are only able to view a particular field in some context, others are allowed to edit it in that same context. The centralized knowledge-base embodied by the L&F enables one single Field definition to take on different forms and behaviors in any context. The security engine 29 is responsible for the correct handling of these specifications depending on who is accessing the fields 43 and in what context.

Workflow Component 17

Workflows 37 are a collection of Actions and Results connected together in a particular configuration. Each configuration, made of Action components 13, Result components 15 and links 38 between them, mirrors different business logic. FIG. 10d is illustrative (discussed later). The security engine 29 audits two major points on the Workflow level:
1. Validate the links connecting Actions and Results if they obey the standardized inter-communication protocols imposed (a necessity since Action components 13 can be self-defined).
2. Render the correct Workflows 37 for different users as required.
   Page Component 19

Pages 11 contain a set of Workflows 37, and so different users can interact with different Workflows 37 on the same Page 11. The security engine 29 renders each Page 11 in a web application into a different customized consolidated workspace.

As previously mentioned, to provide an efficient personalized service, each user should ideally be interacting with his/her tailor-made web application 12. Because of Concept A's loosely coupled layered hierarchy, the security engine 29 yields a completely customized and unique Page 11 per user, fitting only his/her criteria and specifications. FIG. 5 is illustrative Each Page 11 being unique, the collection of pages 11 forming the web application 12 becomes a unique web application for the user as well. When a Page 11 is requested, the security engine 29 loads the capabilities 31 of the accessing user 10 and serves him/her with the unique generated page 11. Each user 10 has a virtual version of the web application in question.

Workflow Engine 35

The Workflow engine 35 acts on one of the A-Components, namely the Workflow component 17.

The engine 35 implements the logic behind the Action-Result component 13, 15 interaction of FIG. 2c. It also sets out the rules and intercommunication protocols between Actions 13 and Results 15 and delegates the monitoring process for the Security engine 29.

The Workflow engine 35 also enables the creation of workflows 37 through a simple drag and drop process. The engine 35 guarantees efficient, simple and on-the spot building and modifying of business logics.

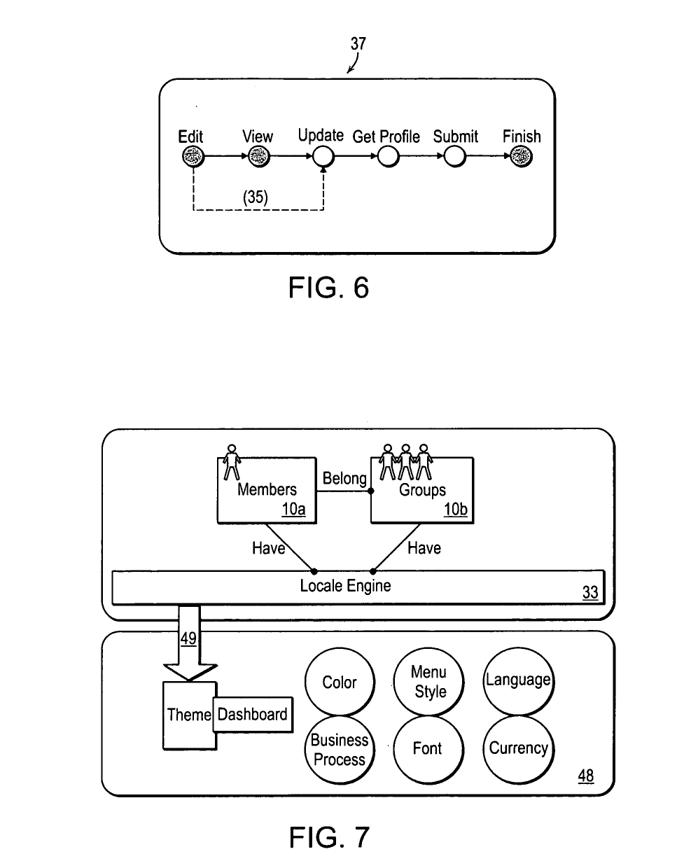

FIG. 6 is a sample workflow 37. The workflow engine 35 enables the simple alteration of this business logic by for example enabling the direct editing and updating of information without first viewing it.

The present invention is an advanced object oriented framework that captures the methodology and knowledge associated with the complex functionality used in developing web-enabled applications.

The present invention incorporates a unique underlying object-oriented environment for representing each web page in the project as a collection of sub pages each driven by a Workflow 37. These Workflows allow for interaction among the multiple disciplines functionality involved in the project with minimal coding and powerful robustness and reusable parts, thus allowing for a concurrent scalable environment compatible with all data sources as well as languages.

The key to fast development lies in the total separation of the business logic and the application code. This separation allows a non-technical domain expert to customize the business logic via wizards.

The present invention streamlines the development process into a single methodology. By adopting the present invention framework, the developer follows an object-oriented methodology. He/she constructs the application as a set of objects that obey an integration protocol and implements a set of standardized methods that ensure the object integrates with the underlying platform. This leaves little room for error and any other developer can pick up from where the previous developer stopped in a seamless manner.

The developer can use his/her favorite web-enabled programming language of choice to implement the transaction procedures. The present invention is in fact a language independent framework, giving full liberty to the developers to use their preferred tools, IDEs and languages.

As such, there are no major learning curve considerations to handle. The present invention merely sets the developers' minds to develop under a fixed sequential manner to ultimately build the present invention subpages and pages as explained earlier.

Benefits and Advantages

The benefits and advantages of adopting the present invention framework are many. Both developers and customers benefit from the large array of features and innovations that the present invention tags along.

The present invention supports locale-based personalization. Upon modification, all changes are automatically propagated along the web application, including text, languages, currencies, images, templates, formulas, dates, fields such as Zip codes and the like. FIG. 7 shows how each member 10a or group 10b belonging to the application tags along his own set of preferences 48. Preferences 48 include currency settings, languages adopted, menu styles, themes, color, font . . . etc. The preferences 48 are effectively a part of the locale the member/group 10 has in his/her profile as shown in FIG. 7.

A centralized control panel is used to update and maintain all parts of the application. Wizards guide administrators through tasks ranging from changing the Look & Feel of the site to managing access control and security settings.

A powerful personalization engine 47 (part of the localization engine 33) allows each user 10 to organize and filter information that is only relevant to his/her personal needs. Each user 10 is able to personalize his/her own interface 49, including setting language, colors, currency, themes, font, menu style, notifications/alerts and the features displayed on the screen while at the same time maintaining the organization's true identity.

Any application built using the present invention has the following,
Security
   Virtual web server creation.
   Application level security.
   Multi-module security schemes.
Modularity and Testability
   Mature Testing plans.
   Integrated testing framework.
   Automated action testing tools.
   Separation between business logic, the design and the core of the application.
Reliability
   Tried and tested modules.
   Efforts focused on testing specific modules.
   Core modules are constantly being revised and upgraded.
   Guaranteed high quality output.
Speed of Development
   Reusable components cut back development time.
   Clear coding structure allows any developer to maintain project code.
   Template-based development speeds up GUI maintenance.
Reduced TCO
   Provides great flexibility for non-technical users.
   Integrated tools as well as wizards reduce maintenance costs.
Aggregation/Integration
   Third party applications
   HTML
   XML
   TXT
   Screen Scraping
   Sockets
   Workflows
   Database engines
   APIs
   Stored procedures

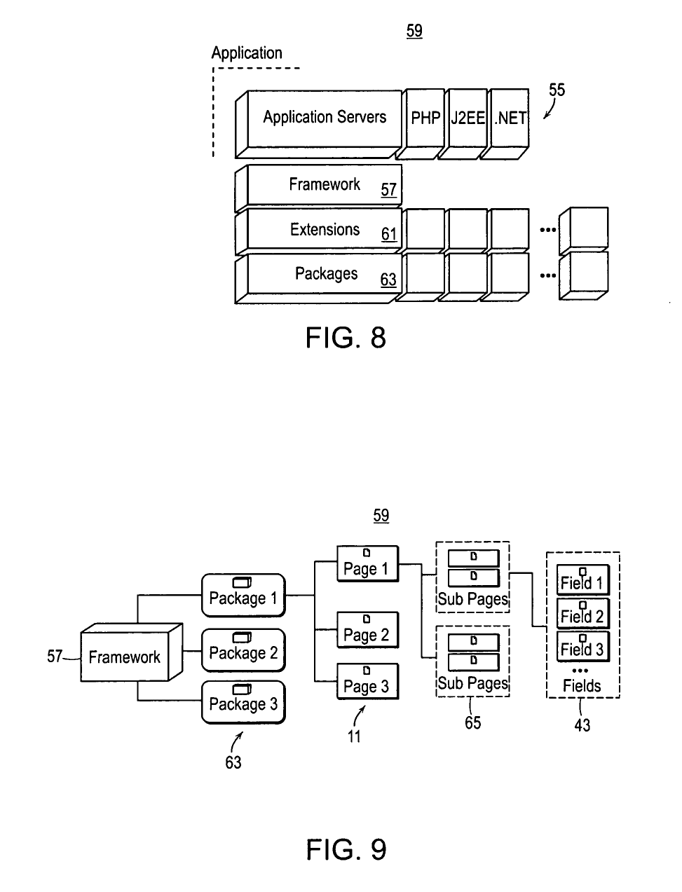

FIGS. 8 and 9 illustrate the concept of the present invention framework. The preferred embodiment 59 can be deployed nowadays on PHP application server, J2EE application server, and NET application server.

The web application then consists of the following:
An Application Server 55.
A present invention Server 57.
A set of present invention Extensions 61.
A set of present invention Packages 63.
A set of newly implemented packages.

Any extension 61 or package 63 consists of pages 11, each page consists of sub-pages 65, and each sub-page 65 consists of fields 43. The present invention empowers one with the ability to add new packages 63, customize existing packages 63 by adding new pages 11 or by customizing its pages 11, sub-pages 65 and/or fields 43. FIG. 9 illustrates the different levels of a preferred embodiment 59.

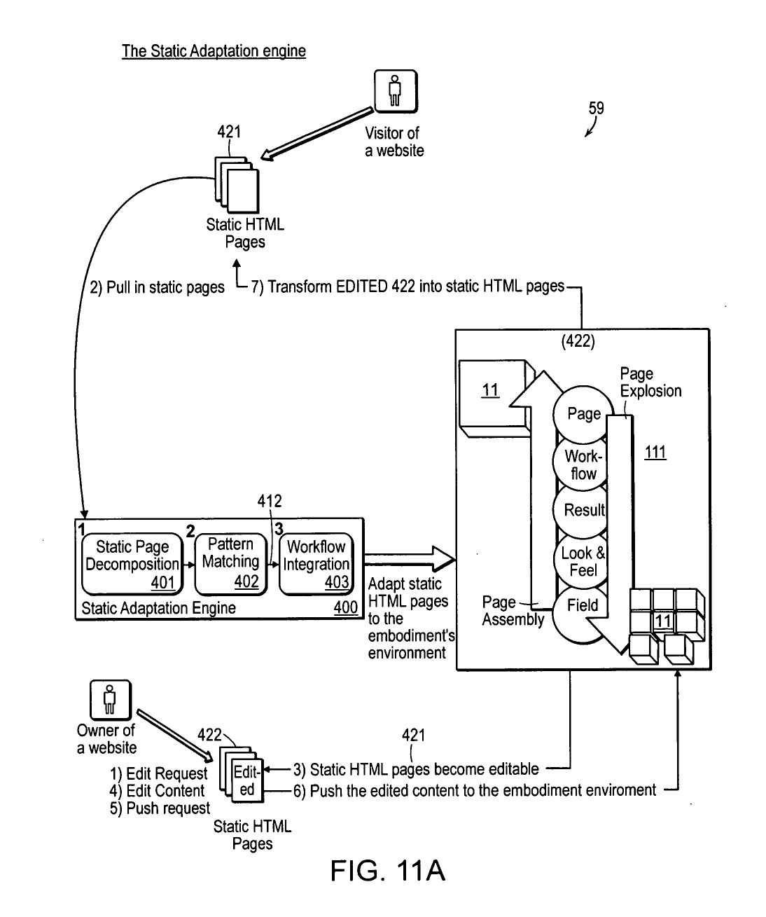

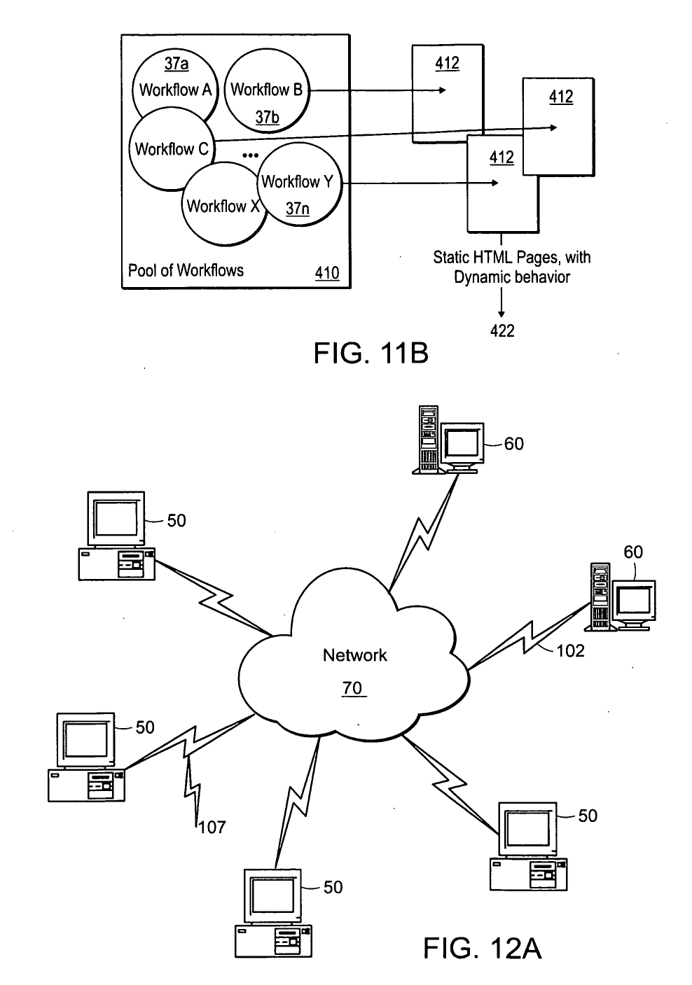

Operation of a preferred embodiment is described next with reference to FIGS. 10a-11b. System 59 generates views for display in a user interface by assembling web pages 11 according to the model or process 111 in FIG. 2b. Upon user interaction (selection, data entry or other actions) with the displayed view 42, the I/O interface of system 59 generates an event. The workflow engine 35 is responsive to the event and serves as a controller 44 for the entire application 12 (as defined below). That is, in prior art system each web page has a respective controller. In contrast, the present invention utilizes a single controller 44 (i.e., via workflow engine 35) across multiple web pages. As such, the event is interpreted and a corresponding request 30, 40 is served with one (common) controller component 44.

The present invention system 59 defines an application 12 by a set of trees 20 of equal depths (e.g., 5 levels). See FIGS. 10a and 10b. In each tree 20, each level maps to an A-Component (e.g., Field Component 14, Look and Feel Component 16, Result Component 15, Workflow Component 17 and Page Component 19), and each node 100, 102, 104, 106, 108 in that level is an instance of that A-Component. Illustrated in FIG. 10a, a tree 20 begins with root 101. Stemming from root 101 is a Page Component 19 level which has two nodes 100a, 100b for example. More or less nodes 100 are acceptable. At a next lower level in the hierarchy is the workflow component 17 level with corresponding node 102. There may be more nodes 102 on this level but only one is shown for simplicity of example. Next in the tree hierarchy is the Results Component 15 level having one or more nodes 104. The succeeding level in the tree 20 is the Look and Feel Component 16 level. There may be one or more nodes 106 at this level (similarly for the other levels). At the lowest or deepest level is the Field Component 14 level with nodes 108a . . . 108n. Illustrated in node 108a is a leaf 99 representing a certain field 43 of a web page 11.

As illustrated in FIG. 10b, in response to a requested web page, the invention system 59 decomposes the subject web page 11 into a tree 20 of A-Component instance nodes 100, 102, 104, 106 and 108. At request time, the system 59 associates each A-Component instance 100, 102, 104, 106, 108 with a unique identifier 18. Preferably the interactions of all the engines 26, 27, 29, 33, 35 with the A-Component instance 100, 102, 104, 106, 108 defines the unique identifier 18. As stated above, a field 43 on the requested web page 11 is a leaf node 99 in the corresponding page tree 20 and is defined (determinable) by a full path from the root 101 of the tree 20 to the leaf node 99.

A full path from the parent node to the leaf 99 is identified by a signature. A signature is defined at request time by an assembly of all the unique identifiers 18 of A-Components along the path from the root 101 to the leaf 99. Techniques and methods common in the art for traversing tree 20 and indexing nodes 100, 102, 104, 106, 108 by unique identifiers 18 are employed. In one embodiment, a concatenation of the unique identifiers 18 in path order of the corresponding nodes forms the signature.

A tree 20 is defined by its A-Component nodes 100, 102, 104, 106, 108. A tree 20 is unique to each request 30, 40, since A-Component nodes are instantiated differently, at request time, based on their interaction with the invention engines (caching engine 26, template engine 27, security engine 29, localization and personalization engine 33 and workflow engine 35).

In the preferred embodiment, a request is automatically translated into as many requests as there are engines 26, 27, 29, 33, 47, 35. Each engine defines part of the A-Component's instance based on (1) the input triplet consisting of the Field template, Field Mode and Personalization Space, and (2) the access rights defined for the user sending the request 30, 40.

Illustrated in FIG. 10b is the handling of a request 30 to view a page 11. The security engine 29 trims the tree 20 from unauthorized nodes on the first request. The security engine 29 uses descriptions of the lowest level concepts in Concept-A which accept input from a user to generate and apply input validation filters on both the client and server sides. The security engine 29 uses the user's security credentials to generate a hierarchical decomposition and reconstruction of the web application's pages 11 from authorized nodes only. It also uses the user's security credentials to determine how to render these authorized nodes with only the authorized functionality level (read-only vs. read-write). This creates a personalized and unique instance of the application 12 that is customized to the user's security credentials.

The workflow engine 35 acts on the nodes 102 of the workflow component level 17 and implements the Action-Result functions and operations as previously discussed in FIG. 6. The workflow engine 35 collects specific information from each node in the tree (i.e., security, data integrity and dependencies) while building the tree 20 and instantiating the A-Components. When a new action is requested from that page, the Workflow engine 35 (along with its collected information), and the unique identifiers 18 of all A-Components, handle any call-back procedure needed to handle that action request. A request to update fields in a page is automatically taken care of by the Workflow engine 35. The engine 35 transparently builds the logic to automatically update fields from their originating source.

Restated, the workflow engine 35 collects the needed information from each node in the tree 20 (security, data integrity and dependencies) to automatically handle any action call back request triggered from the built page 11. A workflow 37 includes a graph of action 13 and result 15 nodes 102. Only one of the result nodes 15, the current result node, is rendered for the user. The Workflow engine 35 executes one or more action nodes 13 to reach another result node 15, which becomes the new current result node and is rendered to the user. It is noted that a workflow node 102 stands on its own and can be reused in other workflows 37.

The localization/personalization engine 33 applies a locale-specific behavior on each node 100, 102, 104, 106, 108 per request (unless it has been traversed by the caching engine 26).

The Template engine 27 traverses the tree 20 in breadth-first manner and (1) recursively renders children nodes, (2) provides the markup content to the parent node, and then (3) renders the parent node (unless it has been traversed by the caching engine 26).

The Caching engine 26 takes the unique identifier 18 of each rendered node in the first two levels of the tree 20 and caches the markup output. The caching employs indexing according to unique identifiers 18. This optimizes the second traversal of the tree 20 by enabling content to be fetched from the cache 28 and thus requiring no tree traversal from any of the engines if the unique identifiers 18 match the second time. The requested web page 11 is assembled via the process 111 of FIG. 2b and is served in a response to view 42. Thus the web page 11 is the result of a tree of A-Components 14, 15, 16, 17, 19 with unique identifiers 18.

FIG. 10c illustrates the handling of a request 30 to view a web page 11 that may be cached. At step a1, system 59 determines whether the subject (requested) page 11 is cached. If so, then system 59 obtains the corresponding page node 100 unique identifier 18 and cache repository location (steps a2, a3). Template engine 27 obtains the subject page contents from cache 28 and sets a final rendered page 11 (steps a4, a5, a6). A response is served with the final rendered page 11 for display in view 42 (step a7).

If at step a1, system 59 determines that the subject page 11 is not cached, then step b1 determines if corresponding workflow 37 (node 102) has been cached. If yes, then steps b2 and b3 obtain the work flow nodes 102 unique identifiers 18 and cache repository location. Template engine 27 obtains the corresponding workflow contents from repository 28 (steps b4 and b5) and sets a final rendered workflow 37 (step b6). As described above, Workflow engine 35 uses the information fetched from cache 28 to update fields of subject page 11 and render a final page 11 to view 42 (step b7).

The handling of an event (action) request 40 is illustrated in FIG. 10d. Controller 44 detects an event (generated by user action) in view 42 and decodes the event into an action request. The system 59 defines the application 12 and corresponding tree 20 for this request as described above. Workflow engine 35 receives the action request and composes appropriate actions components 13 and results components 15 as described previously.

A business logic and the repository 28 of specific information from each node 100, 102, 104, 106, 108 in the tree 20 (i.e., security, data integration and dependencies) define a workflow's 37 behavior. The Workflow engine 35 iterates through a workflow 37 by invoking successive actions 13 until the business logic encounters a result. When the workflow 37 stops at a result, Workflow engine 35 transmits a view request to process 111 which assembles page 11. System 59 serves the resulting page 11 for display in view 42.

Accordingly, each user request 30, 40 defines a unique tree 20, since each user defines unique A-Component instances based on specific engine behaviors on the A-Components. Each user interacts with a unique application 12, since each application 12 is a set of trees 20 unique to the request (and requester-user).

Asynchronous Engine 300

Referring to FIG. 10e, the Asynchronous Engine 300 is a B-Component 53. It is of equal value to the other B-Components (engines 26, 27, 29, 33). The engine 300 benefits from the advent of asynchronous technologies (e.g., AJAX) and the A-Components' hierarchy to enable (1) parallel processing of client requests and (2) parallel assembly/explosion 111 processing of pages 11. The asynchronous engine 300 acts on all A-Components and can be enabled and disabled on any of the levels:

Page & Workflow Components—A Page 11 is composed of Workflow entities 39 with which users interact (see FIG. 3c). The interaction triggers events on both the client and server side. In most cases, the events involve only the workflow entity 39 from which the request originated; all other workflow entities 39 of the subject page 11 remain untouched. The page assembly/explosion process 11 need not involve the whole Page 11. Only a subset of the page (i.e., workflow entity 39 of concern) is processed. This reduces dramatically both processing and rendering costs.

When requests 30, 40 are submitted, the Asynchronous Engine 300 makes sure only the workflow entity 38 of concern is processed and reassembled within a subject page 11. In FIG. 3c, if a user interacts with Workflow C, only that workflow entity 39 is processed and re-rendered in the browser.

Result Components—Result components 15 are containers of fields. Each container is associated with a form. The Asynchronous Engine 300 makes sure containers are processed in parallel within a Result component 15. This leads to on-spot processing and rendering of forms, disregarding all other activities in the Result component 15. Moreover, the Asynchronous Engine 300 makes sure only the container of concern is processed and reassembled within a Result component 15 after an interaction with that container. In FIG. 3b, if a user interacts with Container B (at 41b) in Workflow C, invention system 59 processes only that container 41b and re-renders it in the browser.

Field and Look & Feel Components 14, 16.

Users interact with web applications through fields 43. Fields 43 have properties described in their Look and Feel components 16. They can exhibit different behavior depending on how users interact with them. The Asynchronous Engine 30 makes sure fields 43 are processed in parallel and independently within a container 41.

Referring to FIG. 10e, operation of the Asynchronous Engine 300 in one embodiment is as follows. As previously described, user interaction with a view 42 generates requests 30, 40. Controller 44 is responsive through Workflow engine 35, Security engine 29, Caching engine 26 and Localization engine 33 which generate user-specific, request-specific tree(s) 20. The trees 20 define a unique application 12 for processing the request. Generally the Template engine 27 traverses the tree(s) 20 and provides marked up content to parent nodes and renders said parent nodes in the tree 20.

The Asynchronous Engine 300 provides the option to turn on and off the use of asynchronous calls at any node level in the tree 20. Upon request, the Asynchronous Engine 300 obtains the appropriate marked up tree nodes and provides them for processing in the subject application 12. In turn, the Template engine 27 traverses the tree 20 in a breadth-first manner and recursively adds asynchronous code (e.g., AJAX, JSON, . . . and the like) into each node indicated “AM” in FIG. 10e. The page assembly process 111 generates output where each section or workflow entity 39 in subject (generated) page 11 is rendered separately. That is, system 59 asynchronously sends responses 46 to view 42.

Static Adaptation Engine 400

Also illustrated in FIG. 10e is the Static Adaptation Engine 400. The Static Adaptation Engine 400 is a B-Component 53. It is of equal value to the other B-Components 53 (Engines 26, 27, 29, 33). As shown in FIG. 11a, static HTML pages 421 are fed into the Static Adaptation Engine 400. The engine simplifies the content, structure and markup editing and maintenance of the static-based web pages 421. Moreover, the engine 400 implements dynamic-based functionalities over the pages without affecting the original code. The engine 400 finally outputs the same static HTML pages without any added complexity to the original HTML code.

The engine 400 achieves that end by implementing a different page assembly/explosion process over static-based web pages 421. When a static page 421 is detected, the page is (1) decomposed 401, (2) matched for content and structure patterns at 402 and (3) aggregated with workflow components (step 403). Preferred embodiments of each of these steps are described next.

Static Page Decomposition 401

When a static page 421 is initially loaded, the page explosion process (as implemented by the Static Adaptation Engine 400) first separates content from markup code. When content and markup are treated as independent entities, maintenance operations can be easily and efficiently applied on them. Note that the Static Adaptation Engine 400 assures that the separation of code and markup can be reverted during this page assembly process.

Pattern Matching 402—This step 402 can be applied only when the static page decomposition process 401 is implemented on the static pages 421. Its purpose is to match patterns between pages 421 and enable easy and efficient propagation of changes in websites. Since content and markup are considered as different entities at this stage, the pattern matching process 402 works on both content and markup levels. In particular, the pattern matching process 402 groups content shared between pages 421 as shared resources (e.g., footers, headers). Pattern matching process 402 identifies pages 421 with the same markup structures and convert them to page-templates 21.

Workflow Integration 403

The Static Adaptation Engine 400 enables the integration of already built business processes into static pages. This step introduces no added complexity to the original page code: only one tag is added to the HTML page where the workflow entity 39 is to be added. Dynamic behavior is introduced into static web pages 421 with no extra cost. FIG. 11b is illustrative.

In FIG. 11b, Static Adaptation Engine process step 403 receives on input, page templates 412 of subject static pages 421 from step 402. Workflow Integration step 402 looks to a pool 410 of workflow components (predefined) and obtains the desired ones for integration with the subject static (HTML) page or pages 421. Step 402 adds to a subject HTML page template 412 one tag corresponding to the obtained/desired workflow component. The tag is added to a location in the page template 412 where the corresponding workflow entity 39 is desired. Upon assembly of the static page from edited page template 412 through process 111, the resulting output is edited HTML pages 422 having the desired added dynamic behavior.

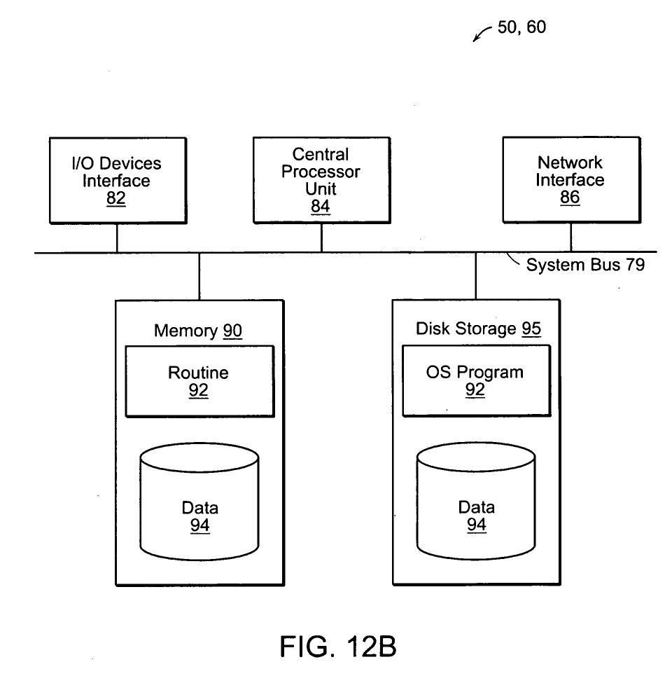

FIG. 12a illustrates a computer network or similar digital processing environment in which the present invention may be implemented.

Client computer(s)/devices 50 and server computer(s) 60 provide processing, storage, and input/output devices executing application programs and the like. Client computer(s)/devices 50 can also be linked through communications network 70 to other computing devices, including other client devices/processes 50 and server computer(s) 60. Communications network 70 can be part of a remote access network, a global network (e.g., the Internet), a worldwide collection of computers, Local area or Wide area networks, and gateways that currently use respective protocols (TCP/IP, Bluetooth, etc.) to communicate with one another. Other electronic device/computer network architectures are suitable.

FIG. 12b is a diagram of the internal structure of a computer (e.g., client processor/device 50 or server computers 60) in the computer system of FIG. 12a. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., keyboard, mouse, displays, printers, speakers, etc.) to the computer 50, 60. Network interface 86 allows the computer to connect to various other devices attached to a network (e.g., network 70 of FIG. 12a). Memory 90 provides volatile storage for computer software instructions 92 and data 94 used to implement an embodiment of the present invention (e.g., engines 26, 27, 29, 33, 35, 300, 400, process 111, and cache 28 of system 59 detailed above). Disk storage 95 provides non-volatile storage for computer software instructions 92 and data 94 used to implement an embodiment of the present invention. Central processor unit 84 is also attached to system bus 79 and provides for the execution of computer instructions.

In one embodiment, the processor routines 92 and data 94 are a computer program product (generally referenced 92), including a computer readable medium (e.g., a removable storage medium such as one or more DVD-ROM's, CD-ROM's, diskettes, tapes, etc.) that provides at least a portion of the software instructions for the invention system. Computer program product 92 can be installed by any suitable software installation procedure, as is well known in the art. In another embodiment, at least a portion of the software instructions may also be downloaded over a cable, communication and/or wireless connection. In other embodiments, the invention programs are a computer program propagated signal product 107 embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium and the like.

While this invention has been particularly shown and described with references to preferred embodiments thereof, it will be understood by those skilled in the art that various changes in form and details may be made therein without departing from the scope of the invention encompassed by the appended claims.

For example, the present invention may be implemented in a variety of computer architectures. The computer network of FIGS. 12a-12b are for purposes of illustration and not limitation of the present invention.

What is claimed is:

1. A method of rendering web pages comprising the computer implemented steps of:
defining a web page based on a vertical structure, the vertical structure having plural layers;
providing a respective engine for each layer in the vertical structure, each engine fulfilling requirements for the respective layer; and
assembling the web page using results of the engines, the assembled web page being displayed to an end user.

2. A method as claimed in claim 1 wherein the web page is displayed to an end user in response to a request; and
further comprising the step of utilizing a common controller across different web pages of a web application, the controller being responsive to requests served from respective web pages.

3. A method as claimed in claim 2 wherein one of the respective engines is a workflow engine, the workflow engine together with workflows of the web application being the single controller of the web application.

4. A method as claimed in claim 1 wherein the web page is one of plural web pages of a web application; and
further comprising the step of representing the web application as a set of trees, each tree having a same number of levels as number of layers in the vertical structure, each tree level corresponding to a different layer in the vertical structure, for a given tree level, each node in that tree level being an instance of the corresponding layer in the vertical structure.

5. A method as claimed in claim 4 wherein the web page is displayed to an end user in response to a request; and
further comprising the step of, at request time, associating each node with a respective unique identifier.

6. A method as claimed in claim 5, the step of associating further comprises the step of defining the unique identifier for a node by interactions between the engines and the node.

7. A method as claimed in claim 4 wherein a field on the web page is represented by a leaf node in one of the trees, the field being determinable from a full path from a root of the one tree to the leaf node.

8. A method as claimed in claim 7 further comprising the steps of:
using a signature to identify the full path from a parent node to the leaf node; and
at request time of the web page, (i) associating each node with a respective unique identifier, and (ii) defining the signature by assembling the unique identifiers of nodes along the path from the root to the leaf node.

9. A method as claimed in claim 4 wherein for a given tree, the tree is unique to a request for the web page, nodes of the tree being instantiated differently at request time based on interaction with the engines.

10. A method as claimed in claim 4 further comprising the steps of:
translating a request from the end-user for the web page into as many requests as there are engines;
each engine defining nodes of a tree level corresponding to the respective layer in the vertical structure corresponding to the engine, the engine defining step being based on (i) a triplet parameter including field template, field mode and personalization space, and (ii) access rights defined for the end-user.

11. A method as claimed in claim 10 wherein a security engine trims the tree from unauthorized nodes on the first request.

12. A method as claimed in claim 10 wherein a localization engine enables a locale-specific behavior to be applied on each node per request.

13. A method as claimed in claim 10 wherein a template engine traverses the tree in breadth-first manner and (1) recursively renders children nodes, (2) provides markup content to a parent node, and then (3) renders the parent node.

14. A method as claimed in claim 10 wherein a caching engine takes a unique identifier of each rendered node in the first two levels of the tree and caches markup output, said caching optimizing a second traversal of the tree by enabling content to be fetched from a cache and no tree traversal from any of the engines to be required if the unique identifiers match at the time of the second traversal.

15. A method as claimed in claim 4 wherein each user request defines a unique tree, since each user defines unique instances of layers in the vertical structure based on specific engine behaviors on the layers; and
wherein each user interacts with a unique web application, since each web application is represented by a set of the trees.

16. A method as claimed in claim 4 wherein the web page is the result of one of the trees, nodes of the one tree each having a respective identifier; and
a workflow engine collects specific information from each node in the tree, when a new action is requested from the web page, the workflow engine together with its collected information and the unique identifiers of the nodes handle any call-back procedure needed to handle that action request.

17. A method as claimed in claim 1 wherein a request to update fields in the web page is automatically taken care of by a workflow engine, the workflow engine transparently building logic to automatically update fields from their originating source.

18. A method as claimed in claim 1 wherein a security engine uses descriptions of the lowest layer concepts in the vertical structure which accept input from a user to generate and apply input validation filters.

19. A method as claimed in claim 1 further comprising the step of providing a page template formed of a hierarchy of specialized templates, each specialized template acting on a particular layer in the vertical structure as the structure is reflected in a hierarchical decomposition of a web page.

20. A computer system for rendering web pages, comprising:
a vertical structure having plural layers, the vertical structure for defining a web page;
a plurality of engines, a respective engine for each layer in the vertical structure, each engine fulfilling requirements for the respective layer; and
assembly means for assembling the web page based on results of the engines and for supporting display of the assembled web page to an end-user.

21. The computer system as claimed in claim 20 wherein the web page includes multiple workflow entities; and
further comprising an asynchronous engine, the asynchronous engine enabling processing and re-rendering of only certain workflow entities of the web page.

22. The computer system as claimed in claim 20 further comprising a static adaptation engine for integrating dynamic behavior into static web pages.
